(19) United States
(12) Patent Application Publication
(10) Pub. No.: US 2025/0198862 A1
(43) Pub. Date: Jun. 19, 2025

(54) PRESSURE SENSOR MODULE AND CONTROL METHOD THEREOF

(71) Applicant: KOREA ELECTRONICS TECHNOLOGY INSTITUTE, Seongnam-si (KR)

(72) Inventors: Won Hyo KIM, Yongin-si (KR); Woo Kyeong SEONG, Seongnam-si (KR)

(73) Assignee: KOREA ELECTRONICS TECHNOLOGY INSTITUTE, Seongnam-si (KR)

(21) Appl. No.: 18/847,783

(22) PCT Filed: Apr. 18, 2023
(86) PCT No.: PCT/KR2023/005248

§ 371 Date: Sep. 17, 2024

(30) Foreign Application Priority Data
Apr. 20, 2022 (KR) 10-2022-0048774

(51) Int. Cl. G01L 1/22

(52) U.S. Cl. CPC G01L 1/2281; G01L 1/2287

(57) ABSTRACT

A pressure sensor module, according to an embodiment of the present invention, comprises: a base substrate; at least one sensing electrode formed on the base substrate; an adhesive layer formed on the base substrate to expose the sensing electrode; a resistance substrate formed on the adhesive layer and having at least one resistor formed thereon to face the sensing electrode; and at least one heater unit formed on the base substrate and including a heating wire formed to be insulated from the sensing electrode. Implemented is a structure in which, on the base substrate, in addition to the sensing electrode for measurement of a pressure sensor, the heater unit including the heating wire is formed together, thereby realizing advantages in manufacturing the pressure sensor module. In addition, the pressure sensor module may be advantageously implemented so as to be capable of optimizing an external pressure and the heating temperature of the heater unit by controlling the pressure sensing and the heater unit together.

### TECHNICAL FIELD

Exemplary embodiments of the present invention relate to a pressure sensor module and a control method therefor.

### BACKGROUND ART

In conventional cases, pressure sensors are coupled to a typical base plate or substrate in the form of a thin film when viewed in plan view.

Accordingly, such a pressure sensor may respond to shrinkage and expansion of the substrate according to deformation, thereby sensing a degree of bending or deformation of the substrate.

For coupling of such a pressure sensor to various devices or wearable devices, necessity of a pressure sensing method using a more effective electrical method is further increasing, in addition to not only an advantage of a physical structure capable of flexing under external pressure, but also measurement of physical pressing force for more effective sensing of the physical pressure as mentioned above.

In addition, necessity of development of a technology for achieving reliability of operation of pressure sensing and a heater function, thinness of a module structure, etc. in association with implementation of the pressure sensing and the heater function is highlighted.

### PRIOR ART LITERATURE

### Patent Documents

Patent Document 1: KR101301277 B1

### DISCLOSURE

### Technical Problem

Therefore, the present invention has been made in view of the above problems, and it is an object of the present invention to provide a pressure sensor module capable of more flexibly coping with external pressure through a pressure sensor employing a flexible base substrate, thereby more effectively enhancing reliability of pressure sensing.

It is another object of the present invention to provide a pressure sensor module in which electrodes for pressure sensing are disposed on a flexible base substrate while intersecting each other, and electrode wirings are connected to the electrodes in one direction and the other direction, respectively, thereby being capable of not only achieving pressure sensing based on external pressure, but also adjusting a heating temperature according to a position or a degree at which pressure is applied, through a heater including a heating wire formed on the base substrate together with the electrode wirings.

It is another object of the present invention to provide a control method for a pressure sensor module capable of enabling pressure sensing and heating to be simultaneously performed or appropriately controlling a heating operation based on a pressure sensing value, through a structure in which a heating wire is formed on a base substrate identical to that of a sensing electrode for pressure sensing or a structure in which a heating wire is formed on a substrate, on which a resistor is formed, simultaneously with formation of the resistor.

### Technical Solution

In accordance with an aspect of the present invention, the above and other objects can be accomplished by the provision of a pressure sensor module including a base substrate, at least one sensing electrode formed at the base substrate, an adhesive layer formed on the base substrate while allowing the sensing electrode to be exposed, a resistor substrate formed on the adhesive layer and formed with at least one resistor facing the sensing electrode, and at least one heater formed on the base substrate while including a heating wire formed to be insulated from the sensing electrode.

In this case, the sensing electrode may include a first sensing electrode and a second sensing electrode coupled to each other to be symmetrical in all directions on a plane while being insulated from each other.

In addition, the heater may include the heating wire formed on the base substrate adjacent to the sensing electrode and configured to provide electrical connection of the heater. The sensing electrode may include a first electrode wiring electrically connected to the first sensing electrode, and a second electrode wiring electrically connected to the second sensing electrode. The heating wire may be formed on the base substrate to be insulated from the first electrode wiring or the second electrode wiring.

In addition, the heating wire may be formed to be insulated from the first and second sensing electrodes and the first and second electrode wirings at one or another surface of the base substrate.

In addition, the resistor may include a plurality of separated resistor patterns configured to be brought into contact with the first sensing electrode and the second sensing electrode to electrically interconnect the first sensing electrode and the second sensing electrode, for mutual conduction of the first sensing electrode and the second sensing electrode.

In accordance with a second embodiment of the present invention, there is provided a pressure sensor module including a base substrate, at least one sensing electrode formed at the base substrate, an insulating layer formed on the base substrate while allowing the sensing electrode to be exposed, a resistor substrate formed on the insulating layer and formed with at least one resistor facing the sensing electrode, and at least one heater formed on the resistor substrate while including a heating wire formed on the insulating layer.

In this case, the sensing electrode may include a first sensing electrode and a second sensing electrode coupled to each other to be symmetrical in all directions on a plane while being insulated from each other.

In addition, the heating wire may be formed at one or another surface of the base substrate to be insulated from the first sensing electrode, the second sensing electrode, a first electrode wiring electrically connected to the first sensing electrode, and a second electrode wiring electrically connected to the second sensing electrode.

In addition, the resistor may include a plurality of separated resistor patterns configured to be brought into contact with the first sensing electrode and the second sensing electrode to electrically interconnect the first sensing electrode and the second sensing electrode, for mutual conduction of the first sensing electrode and the second sensing electrode.

In accordance with a third embodiment of the present invention, there is provided a pressure sensor module including a base substrate, at least one sensing electrode formed on the base substrate, an adhesive layer formed on the base substrate while allowing the sensing electrode to be exposed, a resistor substrate formed on the adhesive layer and formed with at least one resistor facing the sensing electrode, and at least one heater formed on the resistor substrate while including a heating wire formed to be insulated from the resistor.

In this case, the sensing electrode may include a first sensing electrode and a second sensing electrode coupled to each other to be symmetrical in all directions on a plane while being insulated from each other.

In addition, the heating wire may be formed at one or another surface of the base substrate to be insulated from the first sensing electrode, the second sensing electrode, a first electrode wiring electrically connected to the first sensing electrode, and a second electrode wiring electrically connected to the second sensing electrode.

In addition, the resistor may include a plurality of separated resistor patterns configured to be brought into contact with the first sensing electrode and the second sensing electrode to electrically interconnect the first sensing electrode and the second sensing electrode, for mutual conduction of the first sensing electrode and the second sensing electrode.

In accordance with an embodiment of the present invention, there is provided a control method for a pressure sensor module including sensing an external pressure by a pressure sensing unit including a plurality of sensing electrodes on a base substrate, calculating, by a pressure value calculator, a pressure sensing position and a level of a sensed pressure based on a sensing value from the pressure sensing unit, and controlling, by a heating controller, a heater to select a heater area corresponding to the pressure sensing position calculated by the pressure value calculator from among heater areas of the heater and to apply, to the selected heater area, a heating temperature corresponding to a distribution of pressure values calculated by the pressure value calculator.

In this case, the controlling, by a heating controller, a heater may include setting at least two heater areas disposed nearest to the pressure sensing position calculated by the pressure value calculator, and setting heating temperatures of the two heater areas such that the heating temperatures are distributed to correspond to a difference between pressure values calculated by the pressure value calculator.

Features and advantages of the present invention will be more apparent from the following detailed description given with reference to the accompanying drawings.

Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for best explanation.

### Advantageous Effects

In accordance with an embodiment of the present invention, there is an effect of enabling the pressure sensor to flexibly cope with external pressure and effectively enhancing reliability and durability of pressure sensing in accordance with application of a flexible base substrate.

In addition, there is an effect of effectively sensing coordinates (a position) on a plane, to which pressure is applied, simultaneously with sensing of the pressure, by forming the sensing electrodes on the base substrate of the pressure sensor in one direction and the other direction intersecting each other, and electrically connecting the electrode wirings to the sensing electrodes in directions intersecting each other, respectively.

In addition, there is an effect of implementing a pressure sensor module capable of not only providing advantages associated with the manufacture thereof by implementing a structure in which the heater including the heating wire is formed on the base substrate, together with the sensing electrodes of the pressure sensor for measurement of pressure, but also optimizing an external pressure, a heating temperature of the heater, etc. by controlling the heater in association with pressure sensing.

In addition, a bump protruding upwards is additionally formed at an outside of the pressure sensor at a position corresponding to a position at which the sensing electrode and the resistor face each other. Accordingly, external pressure is effectively transmitted to the sensing electrode and the resistor in the form of contact deformation of the sensing electrode and the resistor. Thus, there is an effect of further enhancing accuracy and sensitivity of pressure sensing.

In addition, in formation of the electrode wirings of the sensing electrode of the base substrate, the electrode wirings are disposed on the upper surface and the lower surface of the base substrate such that the electrode wirings are insulated from each other. Accordingly, there is an effect of more effectively securing an insulation structure with respect to the heating wires formed on the base substrate together with the electrode wirings.

In addition, there is an effect of setting a plurality of areas including sensing electrodes to heater areas and controlling the heater areas by appropriately alternatingly disposing heating wires, the sensing electrodes, and electrode wirings at upper and lower surfaces of a base substrate.

Furthermore, when the pressure sensor is used in a seat of a vehicle or a chair, there are effects of effectively preforming a heater function meeting user convenience and achieving an enhancement in energy efficiency by appropriately controlling the heater to correspond to a pressure sensing value obtained through calculation of a pressure sensing position or a pressure value when pressure of the user is sensed by the pressure sensor.

### DESCRIPTION OF DRAWINGS

FIG. 1 a plan view of arrangement of sensing electrodes of a pressure sensor module according to a first embodiment of the present invention.

FIG. 2 is a schematic plan view showing only a heater of the pressure sensor module according to the first embodiment of the present invention.

FIG. 3 is a plan view of the pressure sensor module according to the first embodiment of the present invention.

FIG. 4 is a perspective view of the pressure sensor module according to the first embodiment of the present invention.

FIG. 5 is a cross-sectional view of a portion A of FIG. 4 taken along line AA′.

FIG. 6 is a cross-sectional view of a portion B of FIG. 4 taken along line BB′.

FIG. 7 is a plan view of a resistor substrate of the pressure sensor module according to the first embodiment of the present invention and a cross-sectional view of a part of the resistor substrate.

FIG. 8 is an exploded perspective view of the pressure sensor module according to the first embodiment of the present invention.

FIG. 9 is a plan view showing a modification of a resistor of the resistor substrate in the pressure sensor module according to the first embodiment of the present invention.

FIG. 10 is a plan view showing a state in which the sensing electrode of the pressure sensor module and the resistor in the pressure sensor module according to the first embodiment of the present invention are brought into contact with each other.

FIG. 11 is an enlarged view of the sensing electrode of the pressure sensor module according to the first embodiment of the present invention.

FIG. 12 is an enlarged view of the resistor of the pressure sensor module according to the first embodiment of the present invention.

FIG. 13 is an enlarged view showing a contact form between the sensing electrode and the resistor in the pressure sensor module according to the first embodiment of the present invention.

FIG. 14 is an enlarged view of a modification of the resistor in the pressure sensor module according to the first embodiment of the present invention.

FIGS. 15 and 16 are schematic views showing operation of the pressure sensor module according to the first embodiment of the present invention.

FIG. 17 is an exploded perspective view of a pressure sensor module according to a second embodiment of the present invention.

FIG. 18 is an exploded perspective view of a pressure sensor module according to a third embodiment of the present invention.

FIG. 19 is a schematic view showing a pressure sensor module control method according to an embodiment of the present invention.

### BEST MODE

Objects, particular advantages and new features of the present invention will be more clearly understood from the following detailed description and preferred embodiments taken in conjunction with the accompanying drawings. In the specification, in adding reference numerals for elements in each drawing, it should be noted that like reference numerals already used to denote like elements in other drawings are used for elements wherever possible. In addition, the terms “one surface”, “the other surface”, “first” and “second” are used to differentiate one constituent element from the other constituent element, and these constituent elements should not be limited by these terms. In the following description, when the detailed description of the relevant known function or configuration is determined to unnecessarily obscure the subject matter of the present invention, such detailed description will be omitted.

Hereinafter, exemplary embodiments of the present invention will be described in detail with reference to the accompanying drawings. The same reference numerals in the drawings designate the same elements, respectively.

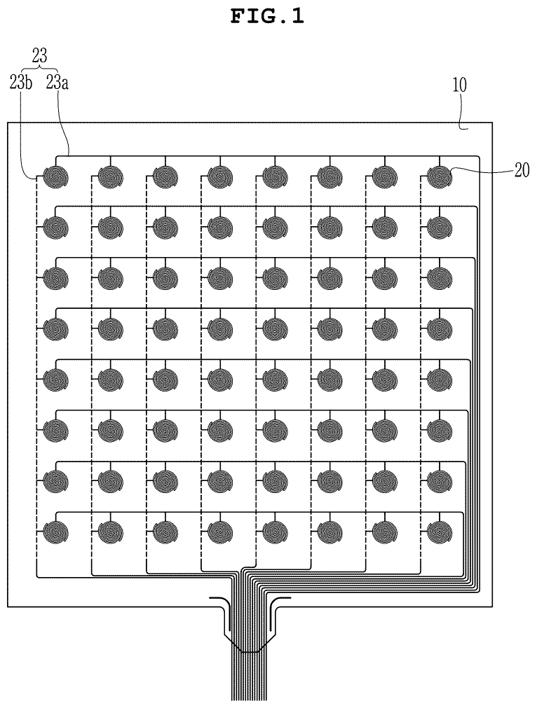

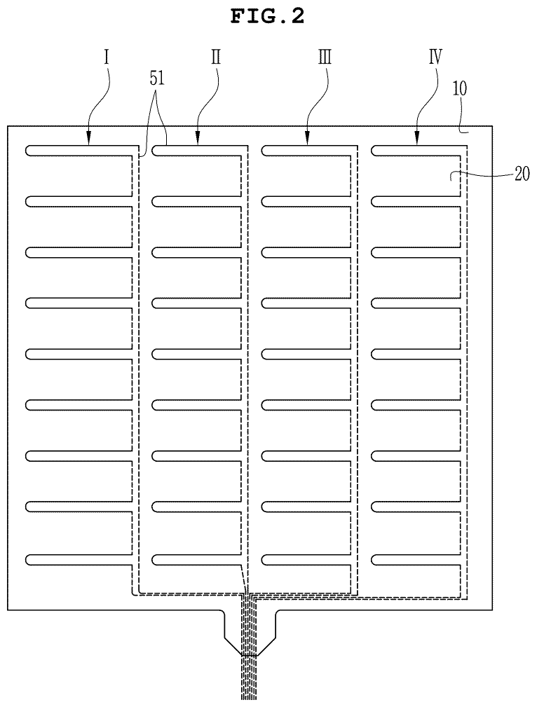

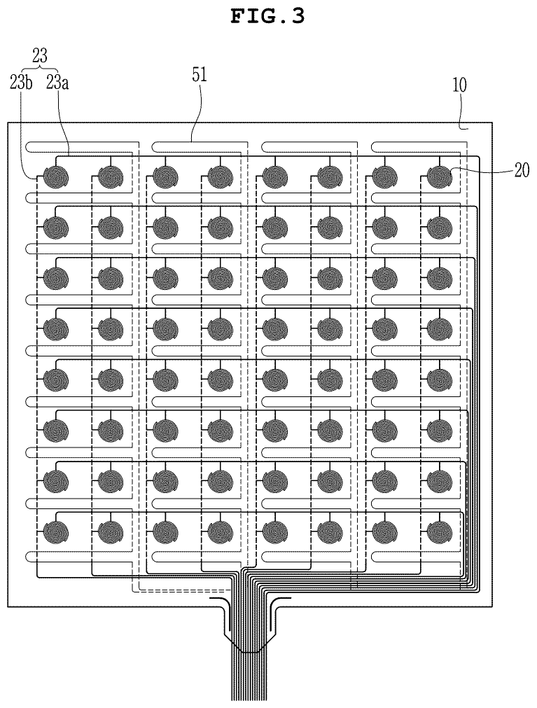

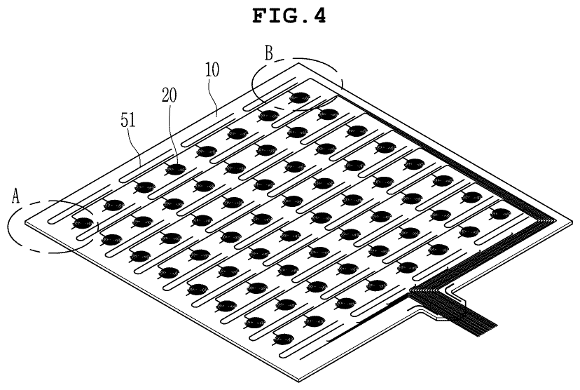

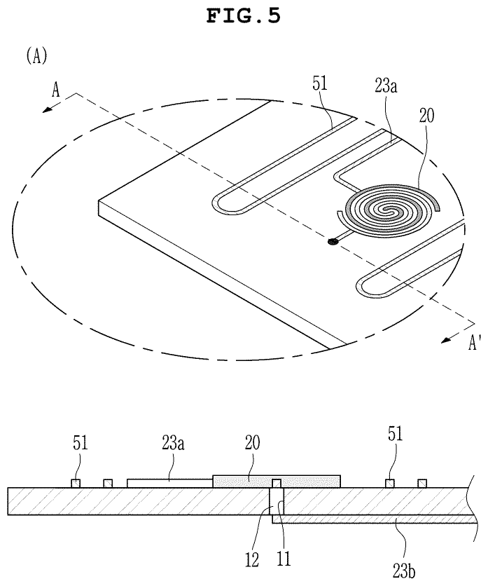

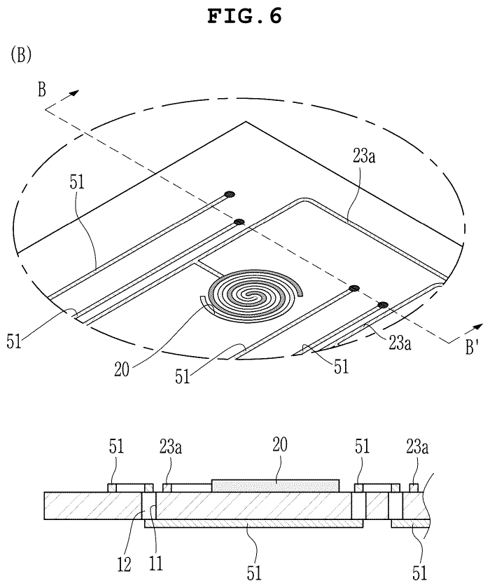

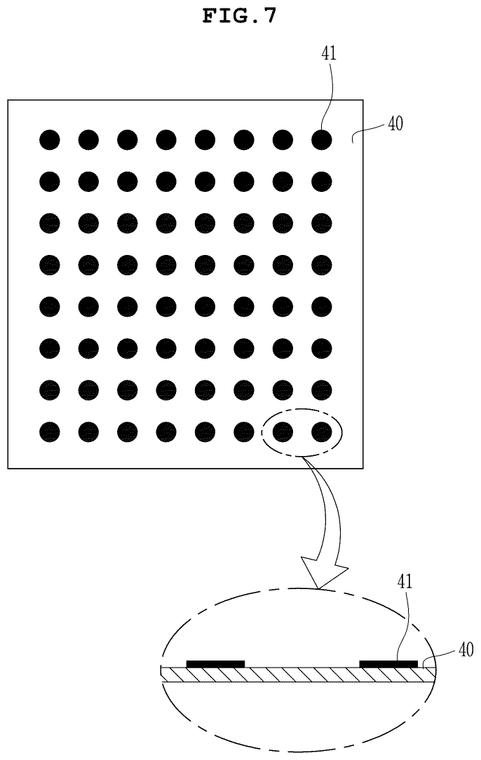

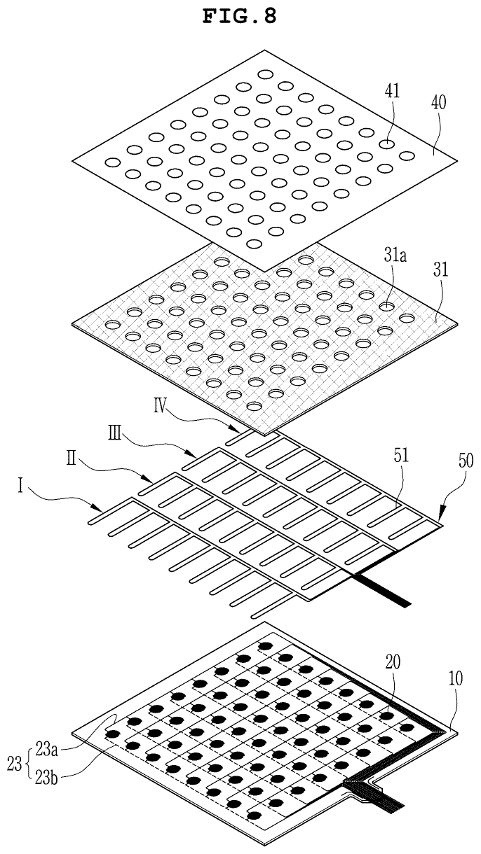

FIG. 1 is a plan view of arrangement of sensing electrodes of a pressure sensor module according to a first embodiment of the present invention. FIG. 2 is a schematic plan view showing only a heater of the pressure sensor module according to the first embodiment of the present invention. FIG. 3 is a plan view of the pressure sensor module according to the first embodiment of the present invention. FIG. 4 is a perspective view of the pressure sensor module according to the first embodiment of the present invention. FIG. 5 is a cross-sectional view of a portion A of FIG. 4 taken along line AA′. FIG. 6 is a cross-sectional view of a portion B of FIG. 4 taken along line BB′. FIG. 7 is a plan view of a resistor substrate of the pressure sensor module according to the first embodiment of the present invention and a cross-sectional view of a part of the resistor substrate. FIG. 8 is an exploded perspective view of the pressure sensor module according to the first embodiment of the present invention.

The pressure sensor module according to the embodiment of the present invention includes a base substrate 10, at least one sensing electrode 20 formed at the base substrate 10, an adhesive layer 31 formed on the base substrate 10 while allowing the sensing electrode 20 to be exposed, a resistor substrate 40 formed on the adhesive layer 31 and formed with at least one resistor 41 facing the sensing electrode 20, and at least one heater 50 formed on the base substrate 10 while including a heating wire 51 formed to be insulated from the sensing electrode 20.

First, as shown in FIG. 1, the sensing electrode 20 may be formed on the base substrate 10, and the electrode wiring 23 for electrical connection of the sensing electrode 20 may be formed on the base substrate 10.

The base substrate 10 is formed with the sensing electrode 20 and the electrode wiring 23 for electrical connection of the sensing electrode 20. In order to enable the base substrate 10 to flexibly move for sensing of external pressure, a flexible printed circuit board may be employed as the base substrate 10, and the base substrate 10 may also be formed using a flexible polyester film or polyimide film having the same physical characteristics as those of the flexible printed circuit board. The base substrate 10 functions as a support substrate for pressure sensing. The base substrate 10 may flexibly cope with pressure applied a plurality of times and, as such, reliability of pressure sensing through the sensing electrode 20 may be further enhanced.

In association with solid-line and dotted-line portions of the electrode wiring 23 shown in the plan view of the pressure sensor module in FIG. 1, the electrode wiring 23 formed at an upper surface of the base substrate 10 is indicated by a solid line, and the electrode wiring 23 formed at a lower surface of the base substrate 10 is indicated by a dotted line. Details of the electrode wirings 23 will be described later.

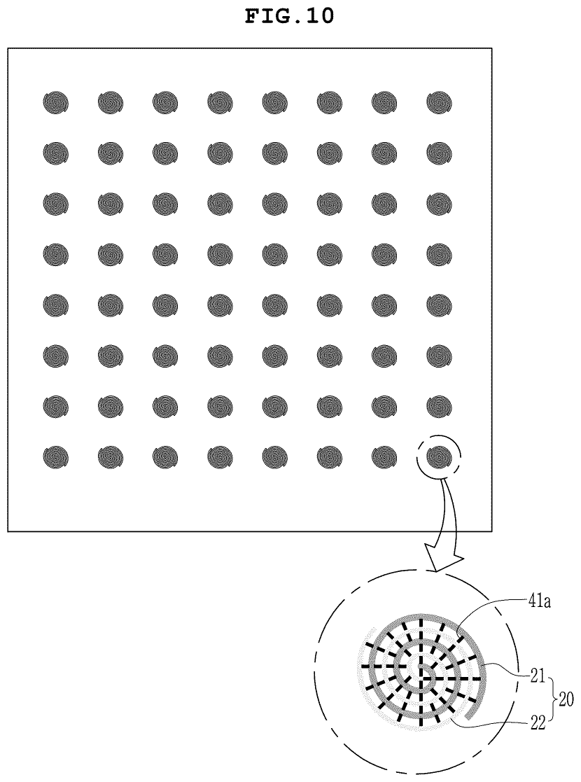

The sensing electrode 20 is constituted by a first sensing electrode 21 and a second sensing electrode 22 insulated from each other (see FIG. 11). In addition, the electrode wiring 23 is constituted by a first electrode wiring 23a electrically connected to the first sensing electrode 21, and a second electrode wiring 23b electrically connected to the second sensing electrode 22.

Since the first sensing electrode 21 and the second sensing electrode 22 are insulated from each other, a region therebetween is in a state in which an infinite resistance is generated. Accordingly, when the resistor 41 of the resistor substrate 40, which will be described later, is brought into contact with the first sensing electrode 21 and the second sensing electrode 22, the first sensing electrode 21 and the second sensing electrode 22 mutually conduct each other. As a result, a reduction in resistance is generated. Through such resistance variation, a pressure value corresponding thereto may be sensed.

In detail, referring to FIG. 1, a plurality of sensing electrodes 20 may be disposed on the base substrate 10 in two axial directions intersecting each other. Of course, sensing of pressure may be achieved using only one sensing electrode 20. However, when a plurality of sensing electrodes 20 is disposed in two axial directions, it may be possible to not only achieve pressure sensing, but also to sense a position of the sensing electrode 20 through which electricity flows.

In detail, the plurality of sensing electrodes 20 is disposed on the base substrate 10 while being spaced apart from one another in one direction and the other direction intersecting each other. The first sensing electrodes 21 of the sensing electrodes 20 arranged in one direction are electrically interconnected by the first electrode wiring 23a, and the second sensing electrodes 22 of the sensing electrodes 20 arranged in the other direction are electrically interconnected by the second electrode wiring 23b.

In order to prevent electrical short circuit of the electrode wirings 23 at a point where the electrode wirings 23 intersect each other and to maximize the sensing area of the sensing electrodes 20 on the base substrate 10, the first electrode wiring 23a and the second electrode wiring 23b may be disposed at the upper surface and the lower surface of the base substrate 10, respectively, or may be appropriately disposed at both the upper surface of the base substrate 10 and the lower surface of the base substrate 10 in an intersecting state. Accordingly, it may be possible to not only achieve a maximum sensing density, but also to achieve electrical connection reliability.

In addition, the position of the sensing electrode 20 where pressure is applied may be sensed through a difference between electrical signals of the first electrode wiring 23a and the second electrode wiring 23b.

FIG. 1 shows that, in order to form the first electrode wiring 23a and the second electrode wiring 23b on one surface of a power connector, which protrudes from one end of the base substrate 10, for connection to an external power source at one end of the base substrate 10, the second electrode wiring 23b formed at the lower surface of the base substrate 10 may extend again from an end of the base substrate 10 along the upper surface of the base substrate 10 and, as such, may then be connected to the power connector.

Of course, the first electrode wiring 23a may be connected to an upper surface of the power connector at the base substrate 10, and the second electrode wiring 23b may be connected to a lower surface of the power connector at the lower surface of the base substrate 10. In FIG. 1, only one embodiment of disposition of the electrode wirings is illustrated.

FIG. 2 is a view showing the heater 50 at one surface of the base substrate 10. The heater 50 may be formed on the surface of the base substrate 10, at which the sensing electrode 20 is formed, while being insulated and spaced apart from the sensing electrode 20. As shown in FIG. 3, the sensing electrode 20 and the heater 50 may be formed to be insulated from each other.

The heating wire 51 of the heater 50 may be formed along a periphery of the sensing electrode 20 while being adjacent to the sensing electrode 20. The heating wire 51 is formed to be also insulated from the electrode wiring 23 for connection of the sensing electrode 20. The heating wire 51 may form one or more heaters independently electrically connected for heat generation. Here, the heating wire 51 may be formed on one surface of the base substrate 10 to form a heater area taking the form of a closed curve. In addition, as shown in FIG. 2, heating wires 51 may be formed to be divided into a plurality of heater areas, that is, a first area I, a second area II, a third area III, and a fourth area IV.

That is, heaters 50 each constituted by one heating wire 51 taking the form of a closed curve form a plurality of heater areas, respectively, and the heating wire 51 of each heater 50 is independently electrically connected such that a heating temperature may be adjusted on a heater area basis.

Although four areas are shown in FIG. 2, a plurality of areas each including the sensing electrode 20 may be set as heater areas, respectively, or the heater 50 may be formed by only one heater area and, as such, the design range or form is not limited to the case shown in the drawing.

As shown in FIGS. 3 and 4, the sensing electrode 20, the electrode wiring 23, and the heating wire 51 of the heater 50 may be disposed at the upper and lower surfaces of the base substrate 10 to intersect one another, for insulation thereof from one another.

As shown in FIG. 3, the electrode wiring 23 of the sensing electrode 20 formed at one surface of the base substrate 10 is indicated by a solid line, and the electrode wiring 23 of the sensing electrode 20 formed at the other surface of the base substrate 10 is indicated by a dotted line. In accordance with such formation, the first electrode wiring 23a of the sensing electrode 20, the second electrode wiring 23b of the sensing electrode 20, and the heating wire 51 of the heater 50 may be maintained to be electrically insulated from one another, thereby preventing electrical short circuit thereamong. Accordingly, reliability of electrical connection for operation of the pressure sensor module may be secured.

FIG. 5 is an enlarged view of the portion A of FIG. 4 and a cross-sectional view taken along line AA′.

As shown in FIG. 5, the heating wire 51 is formed at one surface of the base substrate 10, and the second electrode wiring 23b is disposed at the other surface of the base substrate 10 such that the second electrode wiring 23b is electrically insulated from the heating wire 51. The second electrode wiring 23b may be electrically connected to the sensing electrode 20 at the upper surface of the base substrate 10 through a via hole 11 extending through the one surface and the other surface of the base substrate 10 while being filled with an electrode paste 12.

Similarly, referring to FIG. 6, which is an enlarged view of the portion B of FIG. 4 and a cross-sectional view taken along line BB′, electrical connection of the heating wire 51 to the heating wire 51 at the other surface of the base substrate 10 may be achieved through a via hole 11 filled with an electrode paste 12 and, as such, insulation of the heating wire 51 from the sensing electrode 20 and the electrode wiring 23 at the upper surface of the base substrate 10 may be maintained.

As shown in FIGS. 5 and 6, both the sensing electrode 20 and the heater 50 may be formed at the same base substrate 10 and, as such, reliability of electrical connection therebetween may be secured, and freedom of device application of the pressure sensing module may be enhanced through thinness of the pressure sensing module.

FIG. 7 is a view showing the resistor 41 formed at the resistor substrate 40.

As described above, when the sensing electrode 20 of the base substrate 10 and the resistor 41 of the resistor substrate 40 are brought into contact with each other by external pressure, electricity may flow through the sensing electrode 20, thereby causing a variation in resistance. As a result, pressure sensing may be achieved. The resistor 41 may be formed of a conductor taking a form corresponding to that of the sensing electrode 20. The shape and structure of the resistor 41 may be varied so long as the resistor 41 can contact the sensing electrode 20.

FIG. 8 is an exploded perspective view of the pressure sensor module according to the first embodiment of the present invention. As shown in the drawing, both the sensing electrode 20 and the heater 50 including the heating wire 51 may be formed at the base substrate 10. The adhesive layer 31 may be effectively brought into contact with the resistor 41 of the resistor substrate 40 through a through hole 31a by external pressure. As the adhesive layer 31, an adhesive material constituted by an insulating material may be employed, and various well-known adhesive materials may be employed.

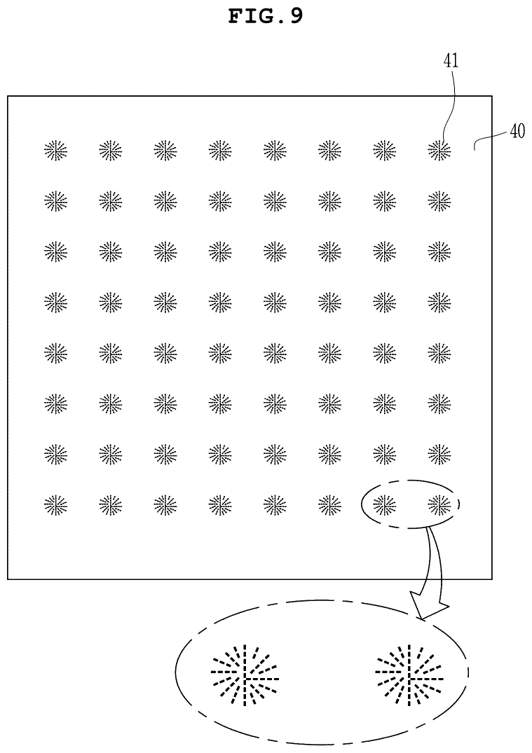

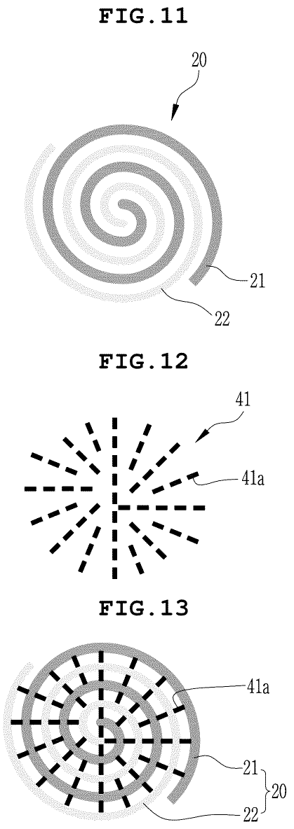

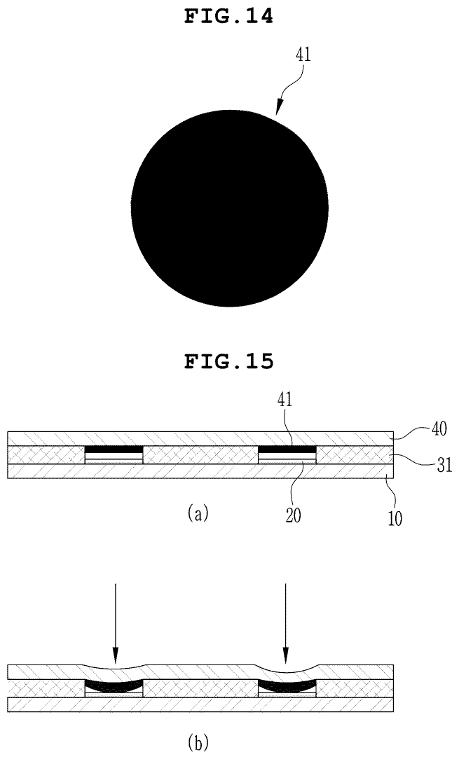

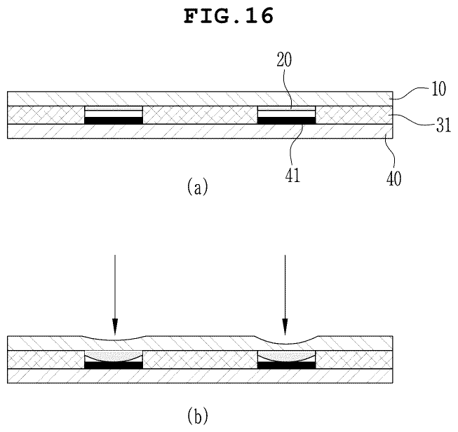

FIG. 9 is a plan view showing a modification of the resistor of the resistor substrate in the pressure sensor module according to the first embodiment of the present invention. FIG. 10 is a plan view showing a state in which the sensing electrode of the pressure sensor module and the resistor in the pressure sensor module according to the first embodiment of the present invention are brought into contact with each other. FIG. 11 is an enlarged view of the sensing electrode of the pressure sensor module according to the first embodiment of the present invention. FIG. 12 is an enlarged view of the resistor of the pressure sensor module according to the first embodiment of the present invention. FIG. 13 is an enlarged view showing a contact form between the sensing electrode and the resistor in the pressure sensor module according to the first embodiment of the present invention. FIG. 14 is an enlarged view of a modification of the resistor in the pressure sensor module according to the first embodiment of the present invention. FIG. 15 and FIG. 16 are schematic views showing operation of the pressure sensor module according to the first embodiment of the present invention.

As shown in FIG. 9, the resistor 41 may be formed of a conductor configured to be brought into contact with the sensing electrode 20, and may include a plurality of resistor patterns 41a.

As shown in FIG. 10, when the first sensing electrode 21 and the second sensing electrode 22 are symmetrically formed to form a space therebetween, the plurality of resistor patterns 41a may be brought into contact with the space between the first sensing electrode 21 and the second sensing electrode 22 by external pressure, thereby causing the first sensing electrode 21 and the second sensing electrode 22 to be electrically interconnected.

Since a plurality of resistor patterns 41a is formed, as shown in FIGS. 11 to 13, it may be possible to quantitatively measure and sense a variation in resistance in accordance with the number of resistor patterns 41a causing the first sensing electrode 21 and the second sensing electrode 22 to be electrically interconnected.

As shown in FIG. 13, the number and the disposition of the plurality of resistor patterns 41a of the resistor 41 may be determined corresponding to an insulation form of the first sensing electrode 21 and the second sensing electrode 22 brought into contact with the plurality of resistor patterns 41a, that is, a form of the space. Accordingly, a variation in resistance according to the number of contacting resistor patterns 41a may be effectively sensed, and the resultant sensed value may be converted into a pressure value.

In addition, as shown in FIG. 14, in the modification of the resistor according to the first embodiment of the present invention, the resistor may be formed by a conductor having a shape corresponding to an outline shape of the sensing electrode.

As the resistor according to this modification is formed by the conductor at the entire surface thereof, the resistance of the sensing electrode is varied in accordance with a variation in the area of the resistor contacting the sensing electrode and, as such, pressure may be sensed.

FIGS. 15 and 16 show a schematic view of an operation in which the sensing electrode 20 and the resistor 41 are brought into contact with each other when the base substrate 10 is flexibly deformed by external pressure.

As shown in the drawings, when external pressure is applied in a direction of the base substrate 10 or the resistor substrate 40, the sensing electrode 20 and the resistor 41 are brought into contact with each other and, as such, a variation in resistance is generated through electrical conduction. Through such a variation in resistance, it may be possible to sense and measure a pressure value.

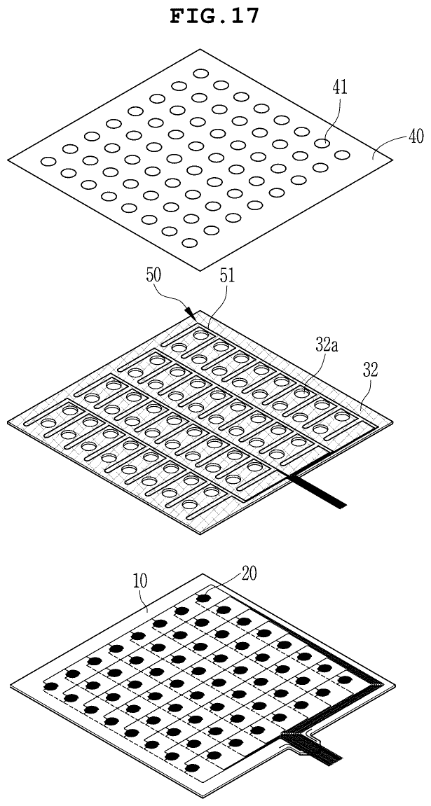

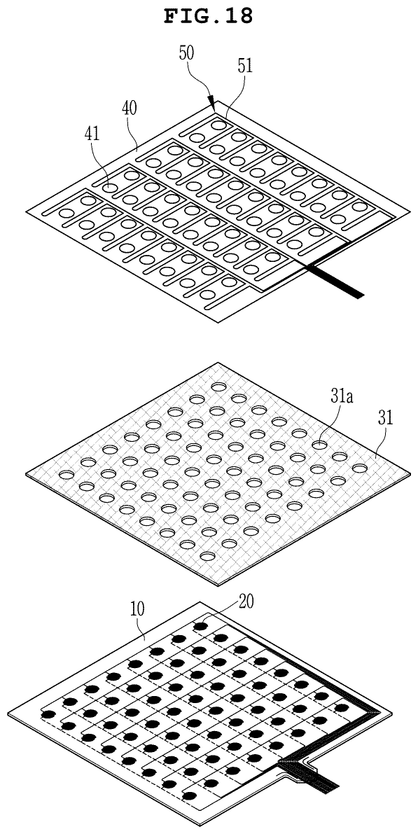

FIG. 17 is an exploded perspective view of a pressure sensor module according to a second embodiment of the present invention.

The pressure sensor module according to the second embodiment of the present invention includes a base substrate 10, at least one sensing electrode 20 formed at the base substrate 10, an insulating layer 32 formed on the base substrate 10 while allowing the sensing electrode 20 to be exposed, a resistor substrate 40 formed on the insulating layer 32 and formed with at least one resistor 41 facing the sensing electrode 20, and at least one heater 50 formed on the resistor substrate 40 while including a heating wire 51 formed on the insulating layer 32.

The second embodiment of the present invention is different from the first embodiment of the present invention in that the heater 50 including the heating wire 51 is formed on the separate insulating layer 32. The insulating layer 32 is stacked on the base substrate 10, and the heater 50 including the heating wire 51 is formed on the insulating layer 32, and, as such, the heater 50 may be maintained to be insulated from the sensing electrode 20 or the electrode wiring 23 on the base substrate 10. Of course, it is preferred that the heater 50 be formed in an area except for an area where the resistor 41 and the sensing electrode 20 are brought into contact with each other through a through hole 32a of the insulating layer 32.

Preferably, the insulating layer 32 is formed of a flexible material having a film shape and, as such, may appropriately cope with deformation of the pressure sensor module caused by external pressure. As the insulating layer 32, a well-known film made of an insulating material may be employed. Of course, a material having electrical insulation and physical properties may also be appropriately employed.

The base substrate 10, the sensing electrode 20, the resistor substrate 40, and the heater 50 are substantially identical to those of the above-described pressure sensor module according to the first embodiment of the present invention and, as such, no overlapping description thereof will be given.

FIG. 18 is an exploded perspective view of a pressure sensor module according to a third embodiment of the present invention.

The pressure sensor module according to the third embodiment of the present invention includes a base substrate 10, at least one sensing electrode 20 formed on the base substrate 10, an adhesive layer 31 formed on the base substrate 10 while allowing the sensing electrode 20 to be exposed, a resistor substrate 40 formed on the adhesive layer 31 and formed with at least one resistor 41 facing the sensing electrode 20, and at least one heater 50 formed on the resistor substrate 40 while including a heating wire 51 formed to be insulated from the resistor 41.

In the pressure sensor module according to the third embodiment of the present invention, the heater 50 including the heating wire 51 is formed on the resistor substrate 40. The heating wire 51 is formed in a space spaced apart from the resistor 41 of the resistor substrate 40 in order to maintain an insulation state from the resistor 41, and a heating function may be achieved through electrical connection of the heating wire 51.

The heater 50 is formed in an area except for a through hole 31a formed to expose the sensing electrode 20 on the adhesive layer 31 such that the through hole 31a may contact the resistor 41. Accordingly, the heater 50 may maintain electrical insulation from the sensing electrode 20 and the electrode wiring 23 on the base substrate 10.

The base substrate 10, the sensing electrode 20, the adhesive layer 31, and the heater 50 are substantially identical to those of the above-described pressure sensor module according to the first embodiment of the present invention and, as such, no overlapping description thereof will be given.

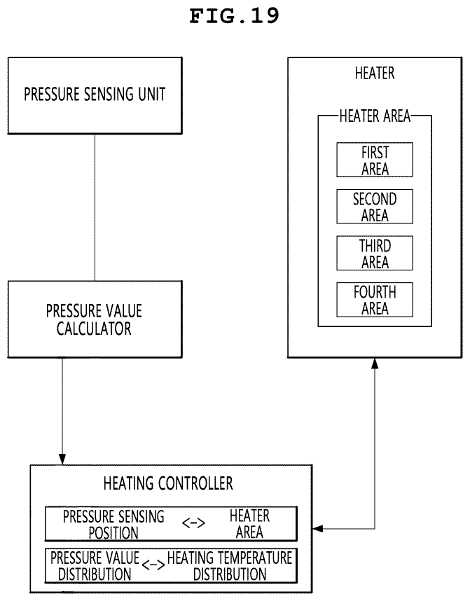

FIG. 19 is a schematic view showing a pressure sensor module control method according to an embodiment of the present invention.

The pressure sensor module control method according to the embodiment of the present invention includes sensing an external pressure by a pressure sensing unit including a plurality of sensing electrodes on a base substrate, calculating, by a pressure value calculator, a pressure sensing position and a level of a sensed pressure based on a sensing value from the pressure sensing unit, and controlling, by a heating controller, a heater to select a heater area corresponding to the pressure sensing position calculated by the pressure value calculator from among heater areas of the heater and to apply, to the selected heater area, a heating temperature corresponding to a distribution of pressure values calculated by the pressure value calculator.

As shown in FIG. 19,
first, the sensing an external pressure by a pressure sensing unit including a plurality of sensing electrodes on a base substrate is performed.

A pressure applied from an exterior is sensed by the sensing electrodes formed on the base substrate. As described above, as one sensing electrode and the resistor are brought into contact with each other by the external pressure, a variation in resistance occurs in accordance with electrical conduction of the sensing electrode. Based on such a resistance variation value, a pressure is sensed. The sensing electrodes are formed on the base substrate along two axes intersecting each other and, as such, it may be possible to simultaneously sense a pressure sensing position and a pressure value according to electrical conduction of one sensing electrode.

Next, the calculating, by a pressure value calculator, a pressure sensing position and a level of a sensed pressure based on a sensing value from the pressure sensing unit is performed.

The pressure value calculator calculates the pressure sensing position and the pressure value based on the external pressure sensed by the pressure sensing unit. As the pressure sensing position and the pressure value corresponding thereto are calculated, it may be possible to calculate a heater area and a heating temperature range of a heater to operate subsequently.

Finally, the controlling, by a heating controller, the heater to select a heater area corresponding to the pressure sensing position calculated by the pressure value calculator from among heater areas of the heater and to apply, to the selected heater area, a heating temperature corresponding to a distribution of pressure values calculated by the pressure value calculator is performed.

A heater area in which the heater is to operate is selected based on the pressure sensing position calculated by the pressure value calculator. That is, each heater area is configured to be individually electrically connected by a heating wire taking the form of a closed curve and, as such, a heating temperature of each heater area may be individually controlled. As such a heater area is provided in plural, a heater area disposed at a position nearest to the pressure sensing position may be matched with the pressure sensing position.

Although the heater area is set to correspond to the pressure sensing position, it may be possible to substantially provide a more stable warming effect to the user in accordance with selection of at least two heater areas. As a heater area corresponding to the pressure sensing position or a heater area nearest to at least the pressure sensing position is set, it may be possible to always operate a maximum of up to two heater areas.

The pressure value calculated by the pressure value calculator may be reflected in a setting value of the heating temperature of the heater area. That is, a deviation or a distribution of pressure values according to different pressure sensing positions may be matched with a heater area and a heating temperature of the heater corresponding thereto. As the pressure sensing position and the pressure value as described above are reflected in operation of the heater, it may be possible to effectively secure an effective operation area of the heater and, as such, to enhance energy efficiency of electric power.

Although the present invention has been disclosed in detail through concrete embodiments, those skilled in the art will appreciate that the pressure sensor module and the control method therefor are not limited to the embodiments, and modifications and alterations are possible, without departing from the scope and spirit of the invention. Simple modifications and alterations fall within the scope of the invention, and the protection scope of the invention will be apparent from the appended claims.

### DESCRIPTION OF REFERENCE NUMERALS

10: base substrate
20: sensing electrode
21: first sensing electrode 22: second sensing electrode
23: electrode wiring 23a: first electrode wiring
23b: second electrode wiring
31: adhesive layer 31a: through hole
32: insulating film 32a: through hole
40: resistor substrate 41: resistor
42: resistor pattern
50: heater 51: heating wire
I: first area II: second area
III: third area IV: fourth area

1. A pressure sensor module comprising:
a base substrate;
at least one sensing electrode formed at the base substrate;
an adhesive layer formed on the base substrate while allowing the sensing electrode to be exposed;
a resistor substrate formed on the adhesive layer and formed with at least one resistor facing the sensing electrode; and
at least one heater formed on the base substrate while comprising a heating wire formed to be insulated from the sensing electrode.

2. The pressure sensor module according to claim 1, wherein the sensing electrode comprises a first sensing electrode and a second sensing electrode coupled to each other to be symmetrical in all directions on a plane while being insulated from each other.

3. The pressure sensor module according to claim 2, wherein:
the heater comprises the heating wire formed on the base substrate adjacent to the sensing electrode and configured to provide electrical connection of the heater;
the sensing electrode comprises:
a first electrode wiring electrically connected to the first sensing electrode; and
a second electrode wiring electrically connected to the second sensing electrode; and
the heating wire is formed on the base substrate to be insulated from the first electrode wiring or the second electrode wiring.

4. The pressure sensor module according to claim 3, wherein:
the heating wire is formed to be insulated from the first and second sensing electrodes and the first and second electrode wirings at one or another surface of the base substrate.

5. The pressure sensor module according to claim 2, wherein the resistor comprises a plurality of separated resistor patterns configured to be brought into contact with the first sensing electrode and the second sensing electrode to electrically interconnect the first sensing electrode and the second sensing electrode, for mutual conduction of the first sensing electrode and the second sensing electrode.

6. A pressure sensor module comprising:
a base substrate;
at least one sensing electrode formed at the base substrate;
an insulating layer formed on the base substrate while allowing the sensing electrode to be exposed;
a resistor substrate formed on the insulating layer and formed with at least one resistor facing the sensing electrode; and
at least one heater formed on the resistor substrate while comprising a heating wire formed on the insulating layer.

7. The pressure sensor module according to claim 6, wherein the sensing electrode comprises a first sensing electrode and a second sensing electrode coupled to each other to be symmetrical in all directions on a plane while being insulated from each other.

8. The pressure sensor module according to claim 7, wherein the heating wire is formed at one or another surface of the base substrate to be insulated from the first sensing electrode, the second sensing electrode, a first electrode wiring electrically connected to the first sensing electrode, and a second electrode wiring electrically connected to the second sensing electrode.

9. The pressure sensor module according to claim 7, wherein the resistor comprises a plurality of separated resistor patterns configured to be brought into contact with the first sensing electrode and the second sensing electrode to electrically interconnect the first sensing electrode and the second sensing electrode, for mutual conduction of the first sensing electrode and the second sensing electrode.

10. A pressure sensor module comprising:
a base substrate;
at least one sensing electrode formed on the base substrate;
an adhesive layer formed on the base substrate while allowing the sensing electrode to be exposed;
a resistor substrate formed on the adhesive layer and formed with at least one resistor facing the sensing electrode; and
at least one heater formed on the resistor substrate while comprising a heating wire formed to be insulated from the resistor.

11. The pressure sensor module according to claim 10, wherein the sensing electrode comprises a first sensing electrode and a second sensing electrode coupled to each other to be symmetrical in all directions on a plane while being insulated from each other.

12. The pressure sensor module according to claim 11, wherein the heating wire is formed at one or another surface of the base substrate to be insulated from the first sensing electrode, the second sensing electrode, a first electrode wiring electrically connected to the first sensing electrode, and a second electrode wiring electrically connected to the second sensing electrode.

13. The pressure sensor module according to claim 11, wherein the resistor comprises a plurality of separated resistor patterns configured to be brought into contact with the first sensing electrode and the second sensing electrode to electrically interconnect the first sensing electrode and the second sensing electrode, for mutual conduction of the first sensing electrode and the second sensing electrode.

14. A control method for a pressure sensor module comprising:
sensing an external pressure by a pressure sensing unit comprising a plurality of sensing electrodes on a base substrate;
calculating, by a pressure value calculator, a pressure sensing position and a level of a sensed pressure based on a sensing value from the pressure sensing unit; and
controlling, by a heating controller, a heater to select a heater area corresponding to the pressure sensing position calculated by the pressure value calculator from among heater areas of the heater and to apply, to the selected heater area, a heating temperature corresponding to a distribution of pressure values calculated by the pressure value calculator.

15. The control method according to claim 14, wherein the controlling, by a heating controller, a heater comprises:
setting at least two heater areas disposed nearest to the pressure sensing position calculated by the pressure value calculator; and
setting heating temperatures of the two heater areas such that the heating temperatures are distributed to correspond to a difference between pressure values calculated by the pressure value calculator.
